(19) United States
(12) Patent Application Publication
(10) Pub. No.: US 2022/0392663 A1
(43) Pub. Date: Dec. 8, 2022

(54) COATING PROCESS AND COATING SYSTEM FOR CABLE AND CABLE MANUFACTURED THEREBY

(71) Applicant: Dongguan Ching Tai Electric Wire & Cable Co., Ltd., Dongguan City (CN)

(72) Inventors: Shi-Wen Huang, Dongguan City (CN); Yang Zhou, Dongguan City (CN); Cheng Hao, Dongguan City (CN); Chi-Wan Huang, Dongguan City (CN); Wen-Hsiang Han, Dongguan City (CN); Wen-Cheng Wu, Dongguan City (CN); Xiao-Yong Liu, Dongguan City (CN); Jie Zhang, Dongguan City (CN)

(21) Appl. No.: 17/829,642

(22) Filed: Jun. 1, 2022

Related U.S. Application Data
(60) Provisional application No. 63/197,590, filed on Jun. 7, 2021.

(51) Int. Cl. H01B 7/02; C09D 175/04; H01B 13/00; C09D 7/20

(52) U.S. Cl. CPC H01B 7/0216; C09D 175/04; H01B 13/0036; C09D 7/20

(57) ABSTRACT

The present invention relates to a coating process and a process system for a cable, and a cable manufactured thereby. The process includes: (1) providing the cable; (2) transporting the cable into immersion device, the cable immerged in first solution to form first coating layer thereon; (3) transporting the cable out of the immersion; (4) transporting the cable into coating device through third wire die, the cable immerged in second solution to form second coating layer thereon, the second layer is attached to the cable through the first layer; (5) transporting the cable out of the coating device through fourth wire die, fourth aperture diameter of the fourth wire die is larger than third aperture diameter of the third wire die; and (6) heating the cable to cure the second coating layer. The system includes: a cable providing device; an immersion device; a coating device; and a heating device.

### CROSS-REFERENCE TO RELATED APPLICATION

This application claims priority to U.S. provisional patent application No. 63/197,590, filed Jun. 7, 2021, titled “CABLE COATING PROCESS” by Huang et al., which is hereby incorporated by reference in its entirety.

### BACKGROUND OF THE INVENTION

### Technical Field

The present invention relates to a coating process and a coating system. More particularly, the present invention relates to a cable coating process and a cable coating system and a cable manufactured thereby.

### Description of Related Art

In one traditional shielding mechanism of the electrical cable, the problem of electromagnetic interference is usually addressed by using the combination of metal wrapping material (like aluminum foil, copper foil, or silver foil) and metal conductive shielding layer (like braided or winded copper cable). However, with the development of high speed, high frequency communication cables, the effect of electromagnetic interference becomes more significant. The known shielding mechanism is relatively simple and its shielding effect has limitations. For example, in the medical related technology field, medical equipment is getting more and more precise and delicate. The noise generated during the operation and use of the cable is found to affect the transmission of the signal, thereby affecting the output of the equipment and consequently affect the doctor's diagnosis and treatment. Such example shows the importance of the shielding technology that can provide communication cable with noise-proof and interference-proof characteristics.

One known method is to lay a coating layer on the surface of the insulated core of the cable. However, when laying the coating layer, a large amount of industrial equipment is required in the production line, which complicates the whole process. In addition, since the cable to be coated can't be fixed properly, the thickness of the coating layer can't be controlled properly during the coating process. The known coating process at least has the following drawbacks: (1) the coated cable could not pass quality examination; (2) the thickness of the coating layer could not be adjusted to fit different product needs; and (3) the workflow of changing the thickness of the coating layer is complicated.

Therefore, there exists a need for a production process and system that can simplify the process of providing the coating layer and solve the aforementioned problems.

### SUMMARY

In view of the above-mentioned problems, the present invention is to provide a coating process and a process system for a cable, and a cable manufactured thereby, which can simplify process steps, increase production efficiency, improve product quality, and provide production flexibility.

According to one aspect of the invention, a coating process for a cable is provided. The process includes the following steps: (1) providing the cable; (2) transporting the cable into an immersion device through a first wire die of the immersion device, the immersion device containing a first solution where the cable is immerged so that a first coating layer is formed covering the cable; (3) transporting the cable with the first coating layer out of the immersion device through a second wire die of the immersion device; (4) after leaving the immersion device, transporting the cable with the first coating layer into a coating device through a third wire die of the coating device, the coating device containing a second solution where the cable is immerged so that a second coating layer is formed covering the first coating layer, in which the second coating layer is attached to the cable through the first coating layer; (5) transporting the cable with the first and second coating layers out of the coating device through a fourth wire die of the coating device, in which a fourth aperture diameter of the fourth wire die is larger than a third aperture diameter of the third wire die; and (6) after leaving the coating device, heating the cable to cure the second coating layer to form a coated cable.

In one embodiment, a second aperture diameter of the second wire die is equal to or larger than a first aperture diameter of the first wire die, and the second aperture diameter is equal to, larger than, or smaller than the third aperture diameter.

In one embodiment, the fourth aperture diameter is equal to or larger than a sum of a diameter of the cable and twice a thickness of the second coating layer.

In one embodiment, the first solution includes: polyurethane, isopropanol, lubricant, and adhesion additive, in which the volume proportion of the isopropanol is more than 50%.

In one embodiment, the second solution includes: polyester resin, ethyl acetate or N,N-dimethyl formamide or cyclohexanone or ethylene glycol monoethyl ether acetate, graphite, and promoter, in which the volume proportion of the graphite is no less than 3%, and the volume proportion of ethyl acetate or N,N-dimethyl formamide or cyclohexanone or ethylene glycol monoethyl ether acetate is no less than 20%.

In one embodiment, the process further includes the following step: (7) heating the cable before entering the immersion device.

In one embodiment, the process further includes the following steps: (8) acquiring a current viscosity of the second solution; and (9) adding a control solution into the second solution when the current viscosity is larger than a preset viscosity to dilute the second solution.

In one embodiment, the control solution includes: graphite, ethyl acetate or N,N-dimethyl formamide or cyclohexanone or ethylene glycol monoethyl ether acetate, and promoter, in which the volume proportion of graphite is no less than 3%, and the volume proportion of ethyl acetate or N,N-dimethyl formamide or cyclohexanone or ethylene glycol monoethyl ether acetate is no less than 20%.

According to another aspect of the invention, a coating system is provided. The system includes a cable providing device, an immersion device, a coating device, and a heating device. The cable providing device is used for providing the cable. The immersion device is adjacent to a cable outlet of the cable providing device and includes a first wire die and a second wire die. The cable is transported into the immersion device through the first wire die and transported out of the immerse device through the second wire die. The immersion device contains a first solution where the cable is immerged so that a first coating layer is formed covering the cable. The coating device is adjacent to a cable outlet of the immersion device and includes a third wire die and a fourth wire die. The cable is transported into the coating device through the third wire die and transported out of the coating device through the fourth wire die. A fourth aperture diameter of the fourth wire die is larger than a third aperture diameter of the third wire die. The coating device contains a second solution where the cable is immerged so that a second coating layer is formed covering the first coating layer. The second coating layer is attached to the cable through the first coating layer. The heating device is adjacent to a cable outlet of the coating device and is used for heating the cable after leaving the coating device to cure the second coating layer to form a coated cable.

In one embodiment, a second aperture diameter of the second wire die is equal to or larger than a first aperture diameter of the first wire die, and the second aperture diameter is equal to, larger than, or smaller than the third aperture diameter.

In one embodiment, the fourth aperture diameter is equal to or larger than a sum of a diameter of the cable and twice a thickness of the second coating layer.

In one embodiment, the immersion device includes more than one of the first wire die and more than one of the second wire die so that more than one cables are transported into and transported out of the immersion device.

In one embodiment, the coating device includes more than one of the third wire die and more than one of the fourth wire die so that more than one cables are transported into and transported out of the coating device.

In one embodiment, the system further includes an encapsulating device which is adjacent to a cable outlet of the heating device and is used for encapsulating the coated cable with a wrapping material.

According to yet another aspect of the invention, a cable is provided. The cable is manufactured by a coating process including the following steps: (1) providing the cable; (2) transporting the cable into an immersion device through a first wire die of the immersion device, the immersion device containing a first solution where the cable is immerged so that a first coating layer is formed covering the cable; (3) transporting the cable with the first coating layer out of the immersion device through a second wire die of the immersion device; (4) after leaving the immersion device, transporting the cable with the first coating layer into a coating device through a third wire die of the coating device, the coating device containing a second solution where the cable is immerged so that a second coating layer is formed covering the first coating layer, in which the second coating layer is attached to the cable through the first coating layer; (5) transporting the cable with the first and second coating layers out of the coating device through a fourth wire die of the coating device, in which a fourth aperture diameter of the fourth wire die is larger than a third aperture diameter of the third wire die; and (6) after leaving the coating device, heating the cable to cure the second coating layer to form a coated cable.

According to the aspects and the embodiments of the invention, the coating process and coating system for the cable and the cable manufacturing thereby has the following advantages. By using the wire dies in the immersion device and the coating device, the cable can be held and fixed properly. The thickness of the coating layer on the cable can be well controlled through the wirer dies and can be adjusted by way of replacing the wire dies with the ones have different aperture diameters. As a result, the cable can be fixed properly, the thickness of the coating layer can be well controlled, the production efficiency can be increased, the product quality can be improved, and the coating process can be simplified. Further, by forming the first and second coating layers sequentially, the second layer attaches to the cable through the first layer such that the second layer can be better attached, which also improves the product quality.

### BRIEF DESCRIPTION OF DRAWINGS

The invention can be more fully understood by reading the following detailed description of the embodiment, with reference made to the accompanying drawings as follows:

FIG. 1 is a schematic diagram of a coating system according to the first embodiment of the invention;

FIG. 2 is a flow chart of a coating process according to the first embodiment of the invention;

FIG. 3 is a schematic diagram showing the cable passing through the immersion device;

FIG. 4 is a schematic diagram showing the cable covered by the first coating layer;

FIG. 5 is a schematic diagram showing the cable passing through the coating device;

FIG. 6 is a schematic diagram showing the first coating layer covered by the second coating layer;

FIG. 7 is a schematic diagram of a coating system according to the second embodiment of the invention;

FIG. 8 is a schematic diagram of a coating system according to the third embodiment of the invention;

FIG. 9 is a schematic diagram of a coating system according to the fourth embodiment of the invention;

FIG. 10 is a schematic diagram of a coating system according to the fifth embodiment of the invention;

FIG. 11 is a schematic diagram of a coating system according to the sixth embodiment of the invention;

FIG. 12 is a schematic diagram of a coating system according to the seventh embodiment of the invention;

FIG. 13 is a schematic diagram of a coating system according to the eighth embodiment of the invention; and

FIG. 14 is a schematic diagram of a coating system according to the ninth embodiment of the invention.

### DETAILED DESCRIPTION

The embodiments of the present invention will be elaborated in the below with accompanying drawings. The technical features for achieving one or more purposes of the invention are described herein. A person who skilled in the art would understand the terms used in the detailed description such as “up”, “down”, “left”, “right”, “back”, and “front” are for elaboration in accordance with the orientation of the drawings and are not for limiting the invention. Besides that, the person can perform a variety of modifications and alterations without departing from the spirit and scope of the invention. The embodiments and examples derive therefrom will still consider falling in the scope of the present invention.

According to the embodiments of the invention, a coating process and a coating system for a cable and a cable manufactured thereby are provided so that the production efficiency and the product quality can be improved.

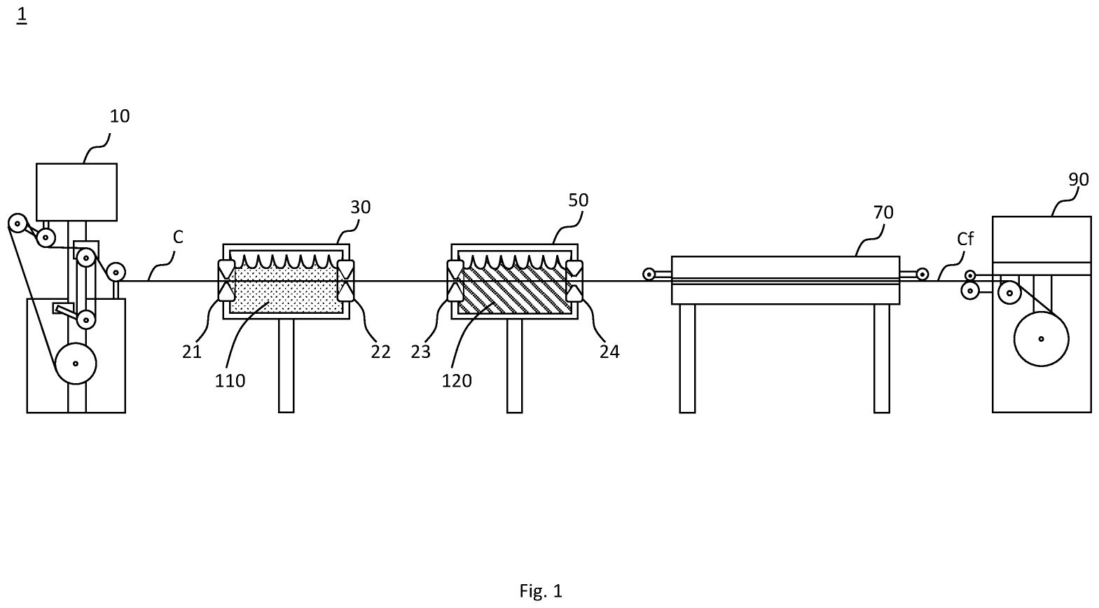

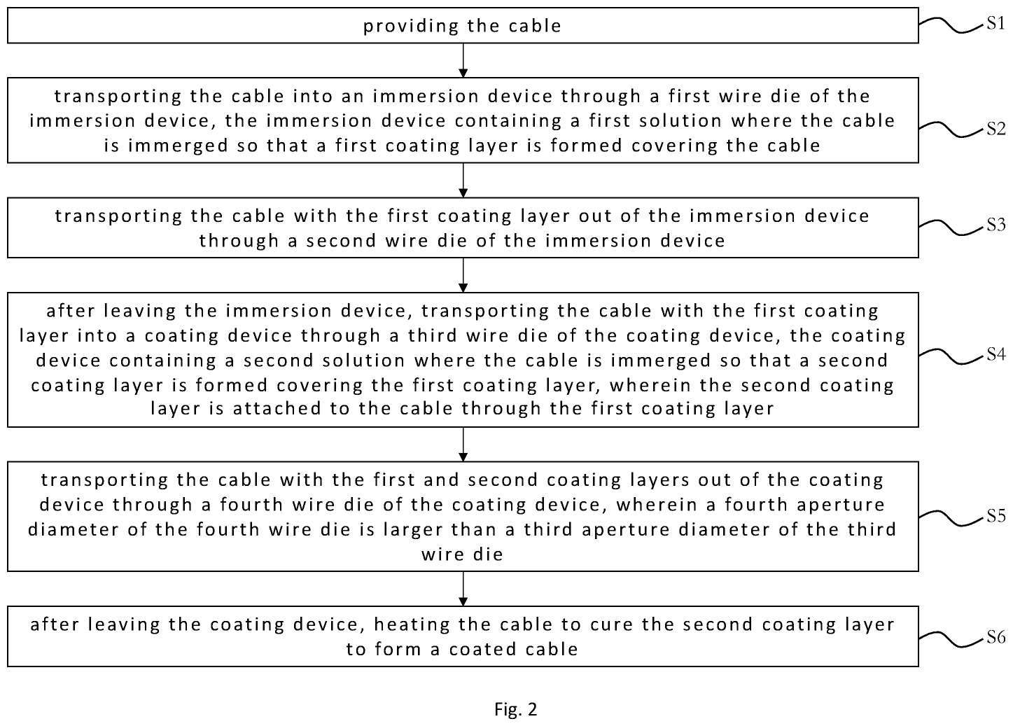

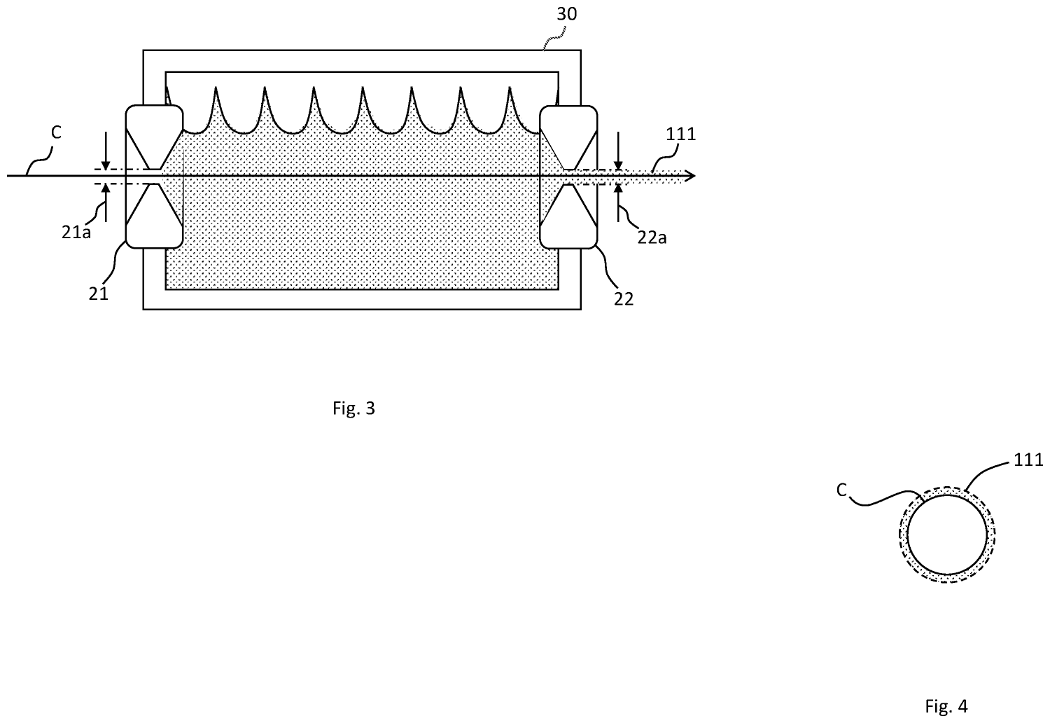

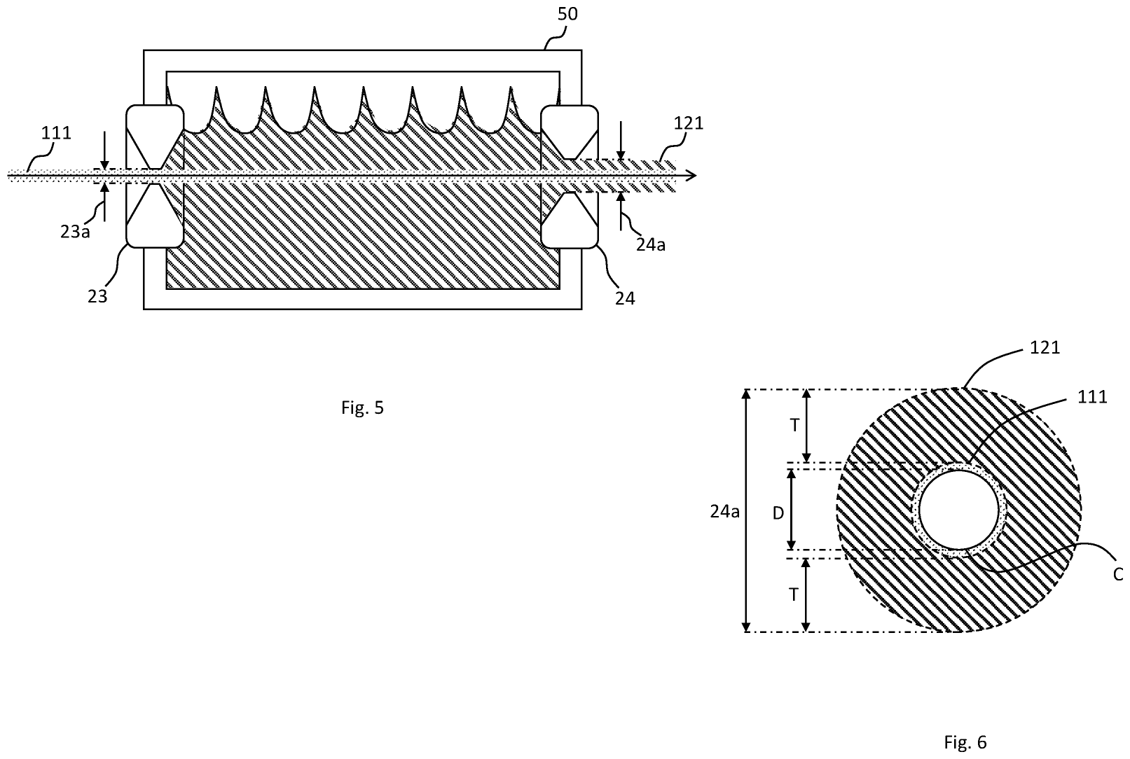

Please refer to FIG. 1 to FIG. 6. FIG. 1 is a schematic diagram of a coating system according to the first embodiment of the invention. FIG. 2 is a flow chart of a coating process according to the first embodiment of the invention. FIG. 3 is a schematic diagram showing the cable passing through the immersion device. FIG. 4 is a schematic diagram showing the cable covered by the first coating layer. FIG. 5 is a schematic diagram showing the cable passing through the coating device. FIG. 6 is a schematic diagram showing the first coating layer covered by the second coating layer. The coating system 1 of the present embodiment at least includes a cable providing device 10, an immersion device 30, a coating device 50, and a heating device 70.

The coating process of the present embodiment includes the following steps. First, in step S1, a cable C to be coated is provided. The cable providing device 10 of the coating system 1 is used for providing the cable C.

Then in step S2, the cable C is transported into the immersion device 30 through a first wire die 21 of the immersion device 30. The immersion device 30 contains a first solution 110 where the cable C is immerged so that a first coating layer 111 is formed covering the cable C. The cable C passes through the first wire die 21 so that it can be transported into the immersion device 30.

Next in step S3, the cable C with the first coating layer 111 is transported out of the immersion device 30 through a second wire die 22 of the immersion device 30. In the present embodiment, a second aperture diameter 22a of the second wire die 22 is equal to or slightly larger than a first aperture diameter 21a of the first wire die 21. The second aperture diameter 22a is equal to or slightly larger than a diameter D of the cable C, so the surface of the cable C can be coated with a thin layer of the first coating layer 111 after passing through the second wire die 22 to leave the immersion device 30.

Further in step S4, after leaving the immersion device 30, the cable C with the first coating layer 111 into a coating device 50 through a third wire die 23 of the coating device 50. The coating device 50 contains a second solution 120 where the cable C is immerged so that a second coating layer 121 is formed covering the first coating layer 111. The second coating layer 121 is attached to the cable C through the first coating layer 111.

Moreover, in step S5, the cable C with the first and second coating layers 111 and 121 is transported out of the coating device 50 through a fourth wire die 24 of the coating device 50. A fourth aperture diameter 24a of the fourth wire die 24 is larger than a third aperture diameter 23a of the third wire die 23. In the present embodiment, the second aperture diameter 22a is smaller than, equal to, or larger than the third aperture diameter 23a. The fourth aperture diameter 24a is equal to or larger than a sum of: (1) the diameter D of the cable C; and (2) twice a thickness T of the second coating layer 121. Therefore, a certain thickness of the second coating layer 121 can be coated onto the surface of the cable C after passing through the fourth wire die 24 to leave the coating device 50.

To be more specific, as shown in FIG. 6, the fourth aperture diameter 24a is larger than or equal to the sum of: (1) the diameter D of the cable C; (2) twice the thickness of the first coating layer 111; and (3) twice the thickness of the second coating layer 121. In the case that the thickness of the first coating layer 111 is so thin that it can be omitted, the fourth aperture diameter 24a is then equal to or larger than the sum of: (1) the diameter D of the cable C; and (2) twice the thickness T of the second coating layer 121.

Practically, by choosing the size of the fourth aperture diameter 24a of the fourth wire die 24, the thickness T of the second coating layer 121 can be changed accordingly. By using such technical solution, the thickness T of the second coating layer 121 can be well controlled and be adjusted. The application flexibility of the coating process and the coating system 1 can be increased.

Afterwards, step S6 is performed. After leaving the coating device 50, the cable C is heated to cure the second coating layer 121 to form a coated cable Cf.

The coating system 1 of the present embodiment further includes a wrapping device 90 which is adjacent to a cable outlet of the heating device 70 and is used for wrapping the coated cable Cf with a wrapping material. The wrapping device 90 is disposed at the end of the coating process. The wrapping material can be exemplified by aluminum foil, copper foil, silver foil, cotton material, or polyester material, and is used for wrapping the coated cable Cf. It is also used as a shielding layer or an isolation layer for the coated cable Cf. In the present embodiment, the wrapping device 90 is further used for cable retracting, such that the wrapped and coated cable Cf is wound into a coil for storage. In another embodiment, the wrapping device 90 and a device for retracting the cable are two separate devices, and they are used for wrapping cable and retracting cable separately. The coating process of the first embodiment of the invention is now completed.

In the first embodiment of the coating process, the first to the fourth wire dies 21 to 24 are disposed in the immersion device 30 and the coating device 50, so the first and second coating layers 111 and 121 can be easily and quickly coated onto the surface of the cable C. The coating process can be simplified.

In the present embodiment, the first solution 110 includes: polyurethane, isopropanol, lubricant, and adhesion additive. The volume proportion of the isopropanol is more than 50%. The first solution 110 is used for improving the adhesion of the second solution 120 on the cable C, so the second solution 120 can be attached to the cable C more effectively. The immersion device 30 is used to let the cable C immerge in the first solution 110 to pretreat the surface of the cable C, thereby achieving the purpose of improving the adhesion of the second solution 120.

Further, the second solution 120 includes: polyester resin, ethyl acetate or N,N-dimethyl formamide or cyclohexanone or ethylene glycol monoethyl ether acetate, graphite, and promoter. The volume proportion of the graphite is no less than 3%, and the volume proportion of ethyl acetate or N,N-dimethyl formamide or cyclohexanone or ethylene glycol monoethyl ether acetate is no less than 20%. In the present embodiment, the second solution 120 is used to form a conductive layer (the second coating layer 121) on the surface of the cable C. The surface of the cable C is fully covered by the conductive layer so as to shield the electromagnetic interference. As a result, the anti-interference ability of the cable C is fortified, the communication quality is increased, and thus the product quality is improved.

The coating process of the present embodiment is not limited to the aforementioned steps S1 to S6. The coating process can further include step S7, the cable C is heated before entering the immersion device 30. The cable C is heated before coated with the first coating layer 111, so the first solution 110 can cover the cable C more effectively.

On the other hand, the coating process can further include step S8 and step S9. In step S8, a current viscosity of the second solution 120 is acquired. Then in step S9, when the current viscosity is larger than a preset viscosity, a control solution is added into the second solution 120 to dilute the second solution 120. In one embodiment, the control solution includes: graphite, ethyl acetate or N,N-dimethyl formamide or cyclohexanone or ethylene glycol monoethyl ether acetate, and promoter. The volume proportion of graphite is no less than 3%, and the volume proportion of ethyl acetate or N,N-dimethyl formamide or cyclohexanone or ethylene glycol monoethyl ether acetate is no less than 20%.

The detail description now directs to the system aspect. The coating system 1 for the cable C of the first embodiment of the invention includes: the cable providing device 10, the immersion device 30, the coating device 50, and the heating device 70. The cable providing device 10 is used for providing the cable C. The immersion device 30 is adjacent to a cable outlet of the cable providing device 10 and includes the first wire die 21 and the second wire die 22. The cable C is transported into the immersion device 30 through the first wire die 21 and transported out of the immerse device 30 through the second wire die 22. The immersion device 30 contains the first solution 110 where the cable C is immerged so that the first coating layer 111 is formed covering the cable C. The coating device 50 is adjacent to a cable outlet of the immersion device 30 and includes the third wire die 23 and the fourth wire die 24. The cable C is transported into the coating device 50 through the third wire die 23 and transported out of the coating device 50 through the fourth wire die 24. The fourth aperture diameter 24a of the fourth wire die 24 is larger than the third aperture diameter 23a of the third wire die 23. The coating device 50 contains the second solution 120 where the cable C is immerged so that the second coating layer 121 is formed covering the first coating layer 111, and the second coating layer 121 is attached to the cable C through the first coating layer 111. The heating device 70 is adjacent to a cable outlet of the coating device 50 for heating the cable C after leaving the coating device 50 to cure the second coating layer 121 to form the coated cable Cf.

In the present embodiment, the second aperture diameter 22a of the second wire die 22 is equal to or slightly larger than the first aperture diameter 21a of the first wire die 21. The second aperture 22a is equal to, smaller than, or larger than the third aperture diameter 23a of the wire die 23. The fourth aperture diameter 24a of the fourth wire die 24 is equal to or larger than the sum of: (1) the diameter D of the cable C; and (2) twice the thickness T of the second coating layer 121.

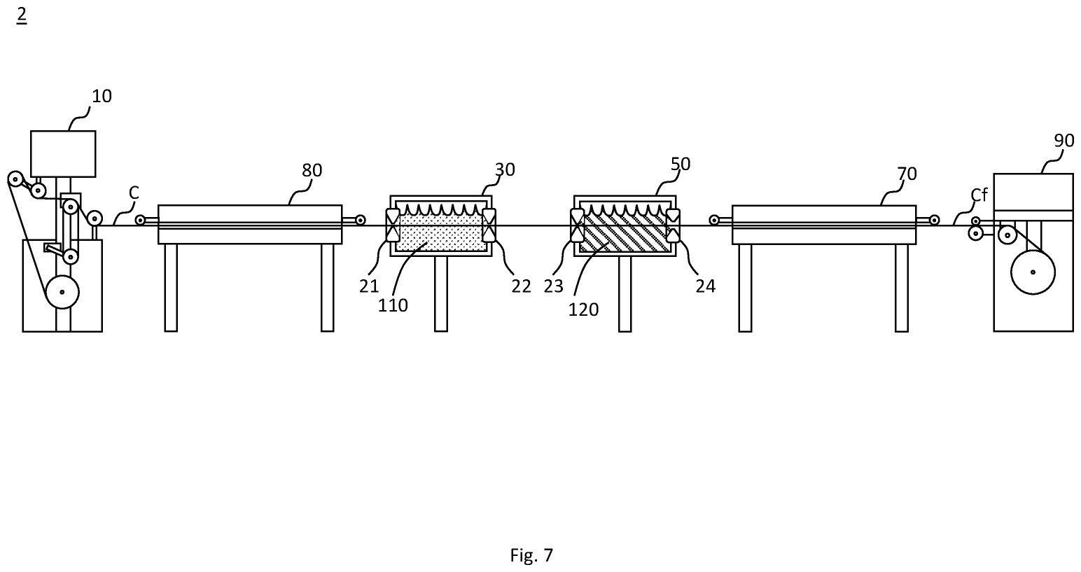

Please refer to FIG. 7, which is a schematic diagram of a coating system according to the second embodiment of the invention. In addition to the cable providing device 10, immersion device 30, coating device 50, the heating device 70, and the wrapping device 90 which are the same as the coating system 1 of the first embodiment, the coating system 2 of the second embodiment further includes another heating device 80 disposed between the cable providing device 10 and the immersion device 30. The heating device 80 is used for heating the cable C before the first coating layer 111 is coated, so the first solution 110 can cover the surface of the cable C more effectively. In another embodiment, more than one of the heating devices 80 can be disposed in the coating system 2.

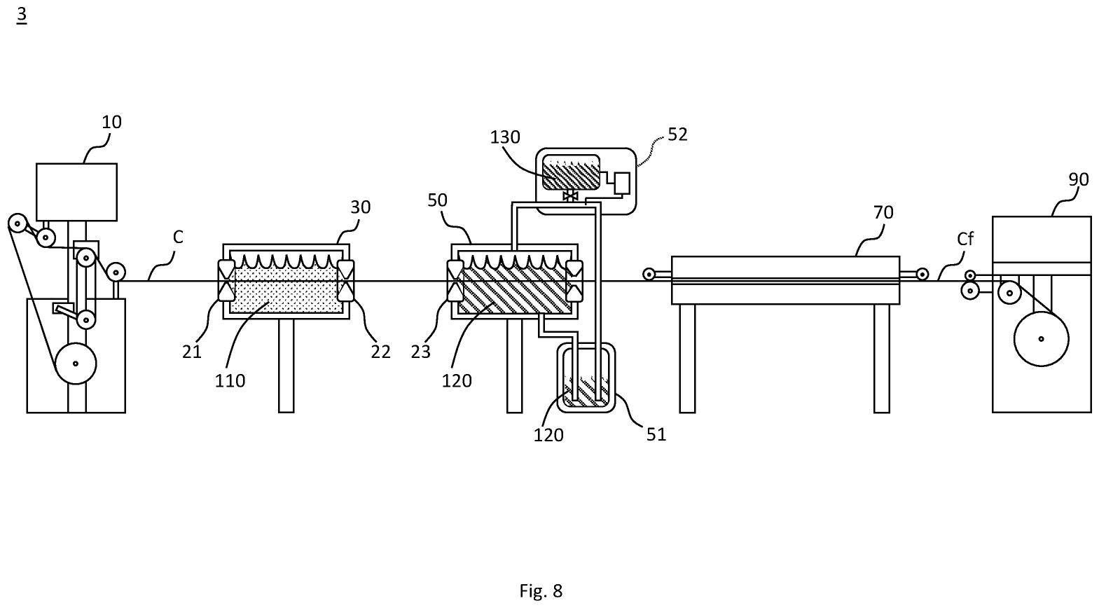

Please refer to FIG. 8, which is a schematic diagram of a coating system according to the third embodiment of the invention. In addition to the cable providing device 10, immersion device 30, coating device 50, the heating device 70, and the wrapping device 90 which are the same as the coating system 1 of the first embodiment, the coating system 3 of the third embodiment further includes a mixing device 51 and an adjusting device 52 for adjusting the viscosity of the second solution 120. The mixing device 51 and the adjusting device 52 are connected to the coating device 50 through pipelines.

In one embodiment, the workflow of adding the second solution 120 into the coating device 50 can be exemplified by the following steps. The second solution 120 is firstly added into the mixing device 51 for automatically mixing (or stirring, agitating. Second, the control solution 130 is added into the adjusting device 52. The adjusting device 52 is activated and is set with the preset viscosity X. During the coating process, the second solution 120 in the mixing device 51 is drawn to the adjusting device 52 via the pipelines, and the adjusting device 52 acquires a current viscosity Y of the second solution 120. When the second solution 120 continues to vaporize during the coating process, its viscosity would be increased, resulting in the current viscosity Y being different from the preset viscosity X (i.e. Y≠X). The second solution 120 then needs to be diluted. In such case, the control solution 130 in the adjusting device 52 starts to be released to dilute the second solution 120. When the preset viscosity X equals the current viscosity Y (i.e. Y=X), the diluted second solution 120 is then fed to the coating device 50 through the pipelines. By way of such dilution mechanism, the second solution 120 maintains in an acceptable range of viscosity, which is beneficial to the coating process. In one embodiment, the control solution 130 includes: graphite, ethyl acetate or N,N-dimethyl formamide or cyclohexanone or ethylene glycol monoethyl ether acetate, and promoter. The volume proportion of graphite is no less than 3%, and the volume proportion of ethyl acetate or N,N-dimethyl formamide or cyclohexanone or ethylene glycol monoethyl ether acetate is no less than 20%.

The cable C entering the coating device 50 is fully submerged in the second solution 120 to be coated with the second coating layer 121, and then transported out of the coating device 50. The remaining second solution 120 in the coating device 50 returns to the mixing device 51 through the recycling pipelines under the coating device 50. In such manner, the second solution 120 can be recycled, thereby realizing automatic circulation of the second solution 120. In the coating system 3, the viscosity can be controlled automatically. The second solution 120 can be replenished by adding in the mixing device 51, so the coating process for the cable C can proceed without interrupted by low amount or high viscosity of the second solution 120. The coating system 3 of the present embodiment realizes the functions of automatically adding the solution and automatically adjusting the viscosity, the coating process can be simplified.

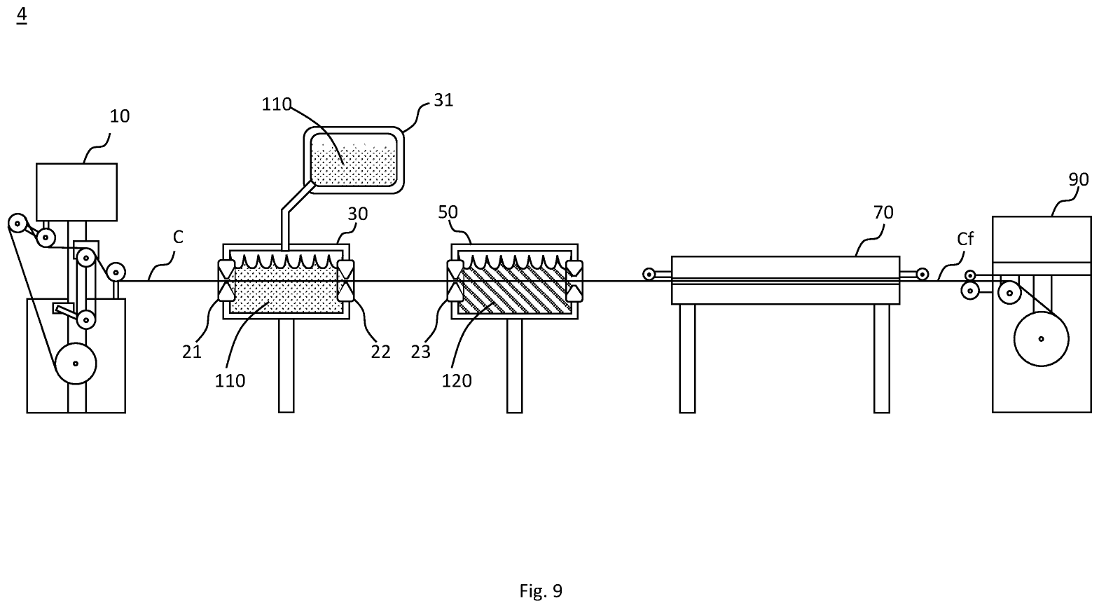

Please refer to FIG. 9, which is a schematic diagram of a coating system according to the fourth embodiment of the invention. In addition to the cable providing device 10, immersion device 30, coating device 50, the heating device 70, and the wrapping device 90 which are the same as the coating system 1 of the first embodiment (as shown in FIG. 1), the coating system 4 of the fourth embodiment further includes a solution dispensing device 31 connecting the immersion device 30 via pipelines. When the first solution 110 is insufficient in the immersion device 30, it can be automatically added by way of supplying the first solution 110 to the immersion device 30. The coating process for the cable C can proceed without interrupted by low amount of the first solution 110. The coating system 4 realizes the functions of automatically adding the solution, the coating process can be simplified.

The coating systems 1 to 4 of the above-mentioned embodiments are all configured for coating a single cable C. However, the coating system of the invention can also be configured for coating more than one cables.

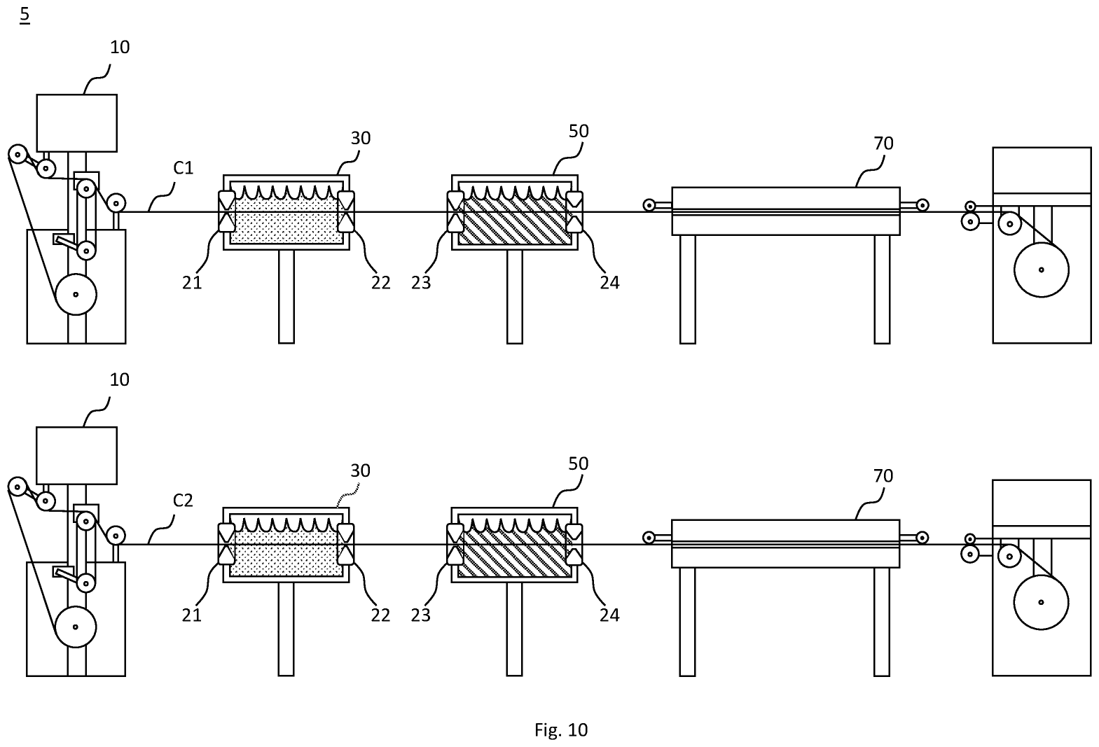

Please refer to FIG. 10, which is a schematic diagram of a coating system according to the fifth embodiment of the invention. The coating system 5 includes two cable providing devices 10, two immersion devices 30, two coating devices 50, two heating devices 70, and two wrapping devices 90. They are used for coating two cables C1 and C2 respectively. The coating system 5 can optionally include one or more heating devices 80 (as shown in FIG. 7) before the two immersion devices 30, depending on the needs of different coating processes and products.

Please refer to FIG. 11, which is a schematic diagram of a coating system according to the sixth embodiment of the invention. In the coating system 6, the immersion device 35 includes more than one of the first wire dies 21 and more than one of the second wire dies 22 through which the cables C1 and C2 are transported into and out of the immersion device 35 respectively. More specifically, the coating system 6 includes two cable providing devices 10, one immersion device 35, two coating devices 50, two heating devices 70, and two wrapping devices 90. The immersion device 35 includes two first wire dies 21 and two second wire dies 22 so the two cables C1 and C2 pass through the first and second wire dies 21 and 22 respectively to enter and leave the immersion device 35. After leaving the immersion device 35, the cables C1 and C2 respectively enter corresponding coating devices 50 and heating devices 70. In this manner, the two cables C1 and C2 can be coated with coating layers in one coating system 6. Further, the coating system 6 can optionally include one or more heating device 80 (as shown in FIG. 7) before the immersion devices 35, depending on the needs of different coating processes and products.

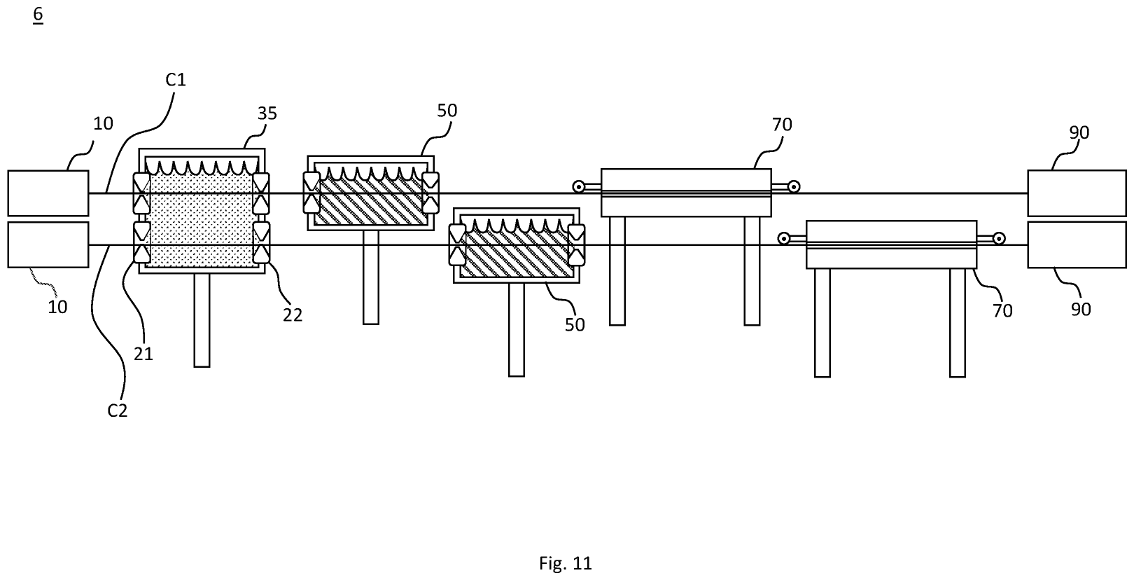

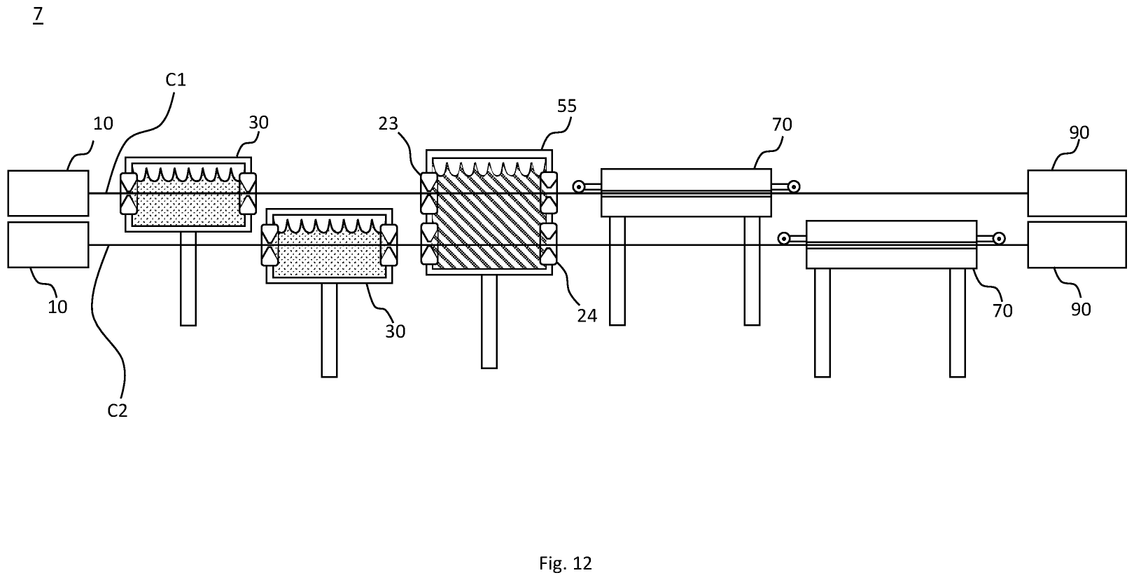

Please refer to FIG. 12, which is a schematic diagram of a coating system according to the seventh embodiment of the invention. In the coating system 7, the coating device 55 includes more than one of the third wire dies 23 and more than one of the fourth wire dies 24 through which the cables C1 and C2 are transported into and out of the coating device 55 respectively. More specifically, the coating system 7 includes two cable providing devices 10, two immersion devices 30, one coating devices 55, two heating devices 70, and two wrapping devices 90. The coating device 55 includes two third wire dies 23 and two fourth wire dies 24 so the two cables C1 and C2 pass through the third and fourth wire dies 23 and 24 respectively to enter and leave the coating device 55. After leaving the coating device 55, the cables C1 and C2 respectively enter corresponding heating devices 70. In this manner, the two cables C1 and C2 can be coated with coating layers in one coating system 7. Further, the coating system 7 can optionally include one or more heating device 80 (as shown in FIG. 7) before the immersion devices 30, depending on the needs of different coating processes and products.

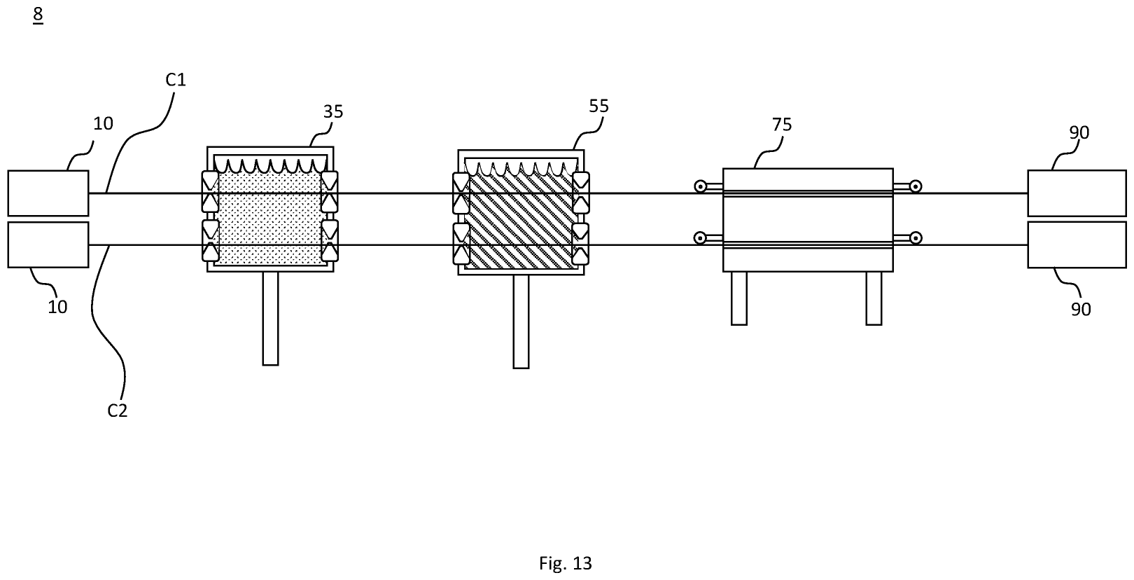

Please refer to FIG. 13, which is a schematic diagram of a coating system according to the eighth embodiment of the invention. The coating system 8 includes two cable providing devices 10, one immersion device 35, one coating device 35, one heating device 75, and two wrapping devices 90. The immersion device 35 and the coating device 55 are the same as the ones described in the embodiments shown in FIG. 11 and FIG. 12. The heating device 75 has a bigger size than the previous heating device 70, so the two cables C1 and C2 run through the heating device 75 in parallel and can be heated at the same time. Further, the coating system 8 can optionally include one or more heating devices 80 (as shown in FIG. 7) before the immersion device 35, depending on the needs of different coating processes and products.

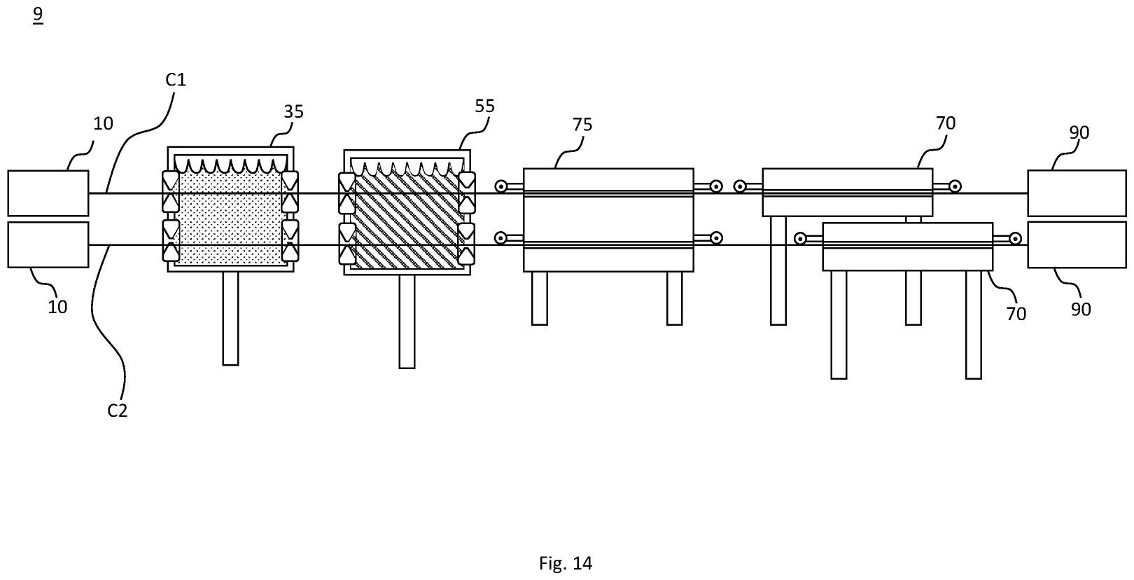

Please refer to FIG. 14, which is a schematic diagram of a coating system according to the ninth embodiment of the invention. The coating system 9 is different from the coating system 8 of FIG. 13 in that the cables C1 and C2 run through the heating device 75 at the same time and then run through the two heating devices 70 respectively. The cables C1 and C2 are heated by the heating devices 70 and 75 to meet the needs of different processes and products. The heating device 75 is larger than the heating devices 70, so the heating device 75 heats the two cables C1 and C2 at the same time, while each heating device 70 only heats one cable C1 or C2. The number of the heating devices 70 and 75 is not limited to that in FIG. 14. The coating system 9 can include more heating device 75 or heating devices 70. In alternative embodiments, the coating system 9 can include only the heating device 75 for two cables C1 and C2, or, the coating system 9 can include only the heating devices 70 each for a single cable C1 or C2. Further, the coating system 9 can optionally include one or more heating devices 80 (as shown in FIG. 7) before the immersion device 35, depending on the needs of difference coating processes and products. The heating device 80 may have the same configuration as the single-cable heating device 70, or alternatively have the same configuration as the multi-cable heating device 75.

A person who is skilled in the art could understand that the immersion device 30, the immersion device 35, the coating device 50, the coating device 55, the heating device 70, the heating device 75, and the heating device 80 can be used alternatively in combination, their configurations and numbers are not limited to the embodiments shown in FIG. 10 to FIG. 14.

According to another embodiment of the invention, a cable manufactured by the above-mentioned coating process is provided.

The embodiments of the invention provide the coating process and coating system for cable and the cable manufactured thereby. By way of using wire dies in the immersion device and the coating device, the cable can be held and fixed properly, and the thickness of the coating layer can be well controlled. The thickness of the coating layer can be changed by using wire dies of different aperture sizes. Further, by sequentially forming the first and the second coating layers, the second layer can be attached to the cable more effectively. The embodiments of the invention have the merits including increasing the production efficiency and improving the product quality.

Practically, before coating the cable, a preparation workflow can be performed in advance. First, required materials are prepared, including preparing the cable to be coated, such as core wire, conductive wire, or semi-finished twisted pairs. The cable can preferably be reeled, and the cable reel is installed and fixed on the cable providing device. Second, the sizes of the wire dies are selected based on the diameter of the cable and the pre-determined thickness of the coating layer. The wire dies are then disposed in the immersion device and the coating device, and make sure the wire dies are fixed properly. Third, the first, second, and control solutions are formulated and respectively added into the immersion device, the coating device, and the adjusting device, or added into the dispensing device and the mixing device so the solutions can be dispensed automatically. Then, the adjusting device is activated and set with the preset viscosity. The control solution can be automatically added in accordance with the changes in the viscosity of the second solution. If the second solution has a relative slow vaporization rate, the control solution can also be omitted in the coating process based on the batch size of production. Further, the temperature of the heating device is set before the coating process starts, so the heating device can warm up in advance. Moreover, the wrapping material and/or the retracting reel is installed on the wrapping device for wrapping the coated cable and retracting the wrapped cable for storage, shipment, transportation, or further processing.

Before commencing the coating process, several checks can be performed, including whether the temperature of the heating device reaches the required level, whether the adjusting device is activated, whether the second solution is agitating in the mixing device, etc. When the coating process begins, the production rate (e.g., 30 meters per minute, m/min.) is set. The cable providing device and the wrapping device are activated simultaneously. The reel of cable waited to be coated and the retracting reel are rotating synchronously. The production rate can be determined by the cable providing device and the wrapping device and can be increase or decrease according to production needs.

After the cable is provided by the cable providing device, the cable can be optionally heated first based on its material and processing requirements. Then the cable passes through the first wire die to enter the immersion device. The surface of the cable is pretreated by submerging in the first solution. The cable then passes through the second wire die to leave the immersion device. The first and second wire dies share the same aperture diameter which can be determined based on the diameter of the cable to be coated (normally slightly larger than the diameter of the cable). The pre-treated cable then passes through the third wire die to enter the coating device. The cable is immerged in the second solution (e.g., conductive solution) so it is fully covered by the solution. Then the cable with two coating layers passes through the fourth wire die to leave the coating device. The fourth aperture diameter of the fourth wire die is larger than the third aperture diameter of the third wire die. The third aperture diameter is slightly larger than the diameter of the cable. The fourth aperture diameter is determined by the diameter of the cable and the thickness of the coating layer. Afterwards, the cable enters one or more heating devices to be heated, so the solvent of the second solution is vaporized to cure the second solution to form a solid layer covering the cable. Finally, the cable is transported to the wrapping device to be wrapped with wrapping material and to be wound about the retracting reel. When the retracting reel reaches its full capacity, the retracting reel with the wound cable thereon is removed from the wrapping device for storage or other purposes. The coating process is completed.

According to the above-mentioned embodiments of the invention, the coating process and coating system for cable and the cable manufactured thereby have the following advantages. By using the wire dies in the immersion device and the coating device, the cable can be held and fixed properly. The thickness of the coating layer on the cable can be well controlled through the wire dies and can be changed by way of replacing the wire dies with the ones have different aperture diameters. As a result, the cable can be fixed properly, the thickness of the coating layer can be well controlled, the production efficiency can be increased, the product quality can be improved, and the coating process can be simplified. Further, by forming the first and second coating layers sequentially, the second layer is attached to the cable through the first layer, and therefore the second layer can be attached more effectively, which also improves the product quality.

The embodiments of the invention are intended for elaboration. It will be apparent to those skilled in the art that various modifications and variations can be made to the embodiments of the present invention without departing from the scope or spirit of the invention. In view of the foregoing, it is intended that the present invention covers modifications and variations of this invention, provided they fall within the scope of the following claims.

What is claimed is:

1. A coating process for a cable, comprising:
(1) providing the cable;
(2) transporting the cable into an immersion device through a first wire die of the immersion device, the immersion device containing a first solution where the cable is immerged so that a first coating layer is formed covering the cable;
(3) transporting the cable with the first coating layer out of the immersion device through a second wire die of the immersion device;
(4) after leaving the immersion device, transporting the cable with the first coating layer into a coating device through a third wire die of the coating device, the coating device containing a second solution where the cable is immerged so that a second coating layer is formed covering the first coating layer, wherein the second coating layer is attached to the cable through the first coating layer;
(5) transporting the cable with the first and second coating layers out of the coating device through a fourth wire die of the coating device, wherein a fourth aperture diameter of the fourth wire die is larger than a third aperture diameter of the third wire die; and
(6) after leaving the coating device, heating the cable to cure the second coating layer to form a coated cable.

2. The coating process according to claim 1, wherein a second aperture diameter of the second wire die is equal to or larger than a first aperture diameter of the first wire die, and the second aperture diameter is equal to, larger than, or smaller than the third aperture diameter.

3. The coating process according to claim 1, wherein the fourth aperture diameter is equal to or larger than a sum of a diameter of the cable and twice a thickness of the second coating layer.

4. The coating process according to claim 1, wherein the first solution comprises: polyurethane, isopropanol, lubricant, and adhesion additive, wherein the volume proportion of the isopropanol is more than 50%.

5. The coating process according to claim 1, wherein the second solution comprises: polyester resin, ethyl acetate or N,N-dimethyl formamide or cyclohexanone or ethylene glycol monoethyl ether acetate, graphite, and promoter, wherein the volume proportion of the graphite is no less than 3%, and the volume proportion of ethyl acetate or N,N-dimethyl formamide or cyclohexanone or ethylene glycol monoethyl ether acetate is no less than 20%.

6. The coating process according to claim 1, further comprising:
(7) heating the cable before entering the immersion device.

7. The coating process according to claim 1, further comprising:
(8) acquiring a current viscosity of the second solution; and
(9) adding a control solution into the second solution when the current viscosity is larger than a preset viscosity to dilute the second solution.

8. The coating process according to claim 7, wherein the control solution comprises: graphite, ethyl acetate or N,N-dimethyl formamide or cyclohexanone or ethylene glycol monoethyl ether acetate, and promoter, wherein the volume proportion of graphite is no less than 3%, and the volume proportion of ethyl acetate or N,N-dimethyl formamide or cyclohexanone or ethylene glycol monoethyl ether acetate is no less than 20%.

9. A coating system for a cable, comprising:
a cable providing device for providing the cable;
an immersion device adjacent to a cable outlet of the cable providing device comprising: a first wire die and a second wire die, wherein the cable is transported into the immersion device through the first wire die and transported out of the immerse device through the second wire die, and the immersion device contains a first solution where the cable is immerged so that a first coating layer is formed covering the cable;
a coating device adjacent to a cable outlet of the immersion device comprising: a third wire die and a fourth wire die, wherein the cable is transported into the coating device through the third wire die and transported out of the coating device through the fourth wire die, a fourth aperture diameter of the fourth wire die is larger than a third aperture diameter of the third wire die, the coating device contains a second solution where the cable is immerged so that a second coating layer is formed covering the first coating layer, and the second coating layer is attached to the cable through the first coating layer; and.
a heating device adjacent to a cable outlet of the coating device for heating the cable after leaving the coating device to cure the second coating layer to form a coated cable.

10. The coating system according to claim 9, wherein a second aperture diameter of the second wire die is equal to or larger than a first aperture diameter of the first wire die, and the second aperture diameter is equal to, larger than, or smaller than the third aperture diameter.

11. The coating system according to claim 9, wherein the fourth aperture diameter is equal to or larger than a sum of a diameter of the cable and twice a thickness of the second coating layer.

12. The coating system according to claim 9, wherein the immersion device comprises a plurality of the first wire dies and a plurality of the second wire dies so that a plurality of the cables are transported into and transported out of the immersion device.

13. The coating system according to claim 9, wherein the coating device comprises a plurality of the third wire dies and a plurality of the fourth wire dies so that a plurality of the cables are transported into and transported out of the coating device.

14. The coating system according to claim 9, further comprising:
a wrapping device adjacent to a cable outlet of the heating device for wrapping the coated cable with a wrapping material.

15. A cable, manufactured by a coating process comprising:
(1) providing the cable;
(2) transporting the cable into an immersion device through a first wire die of the immersion device, the immersion device containing a first solution where the cable is immerged so that a first coating layer is formed covering the cable;
(3) transporting the cable with the first coating layer out of the immersion device through a second wire die of the immersion device;
(4) after leaving the immersion device, transporting the cable with the first coating layer into a coating device through a third wire die of the coating device, the coating device containing a second solution where the cable is immerged so that a second coating layer is formed covering the first coating layer, wherein the second coating layer is attached to the cable through the first coating layer;
(5) transporting the cable with the first and second coating layers out of the coating device through a fourth wire die of the coating device, wherein a fourth aperture diameter of the fourth wire die is larger than a third aperture diameter of the third wire die; and
(6) after leaving the coating device, heating the cable to cure the second coating layer to form a coated cable.
